(19) United States
(12) Patent Application Publication
(10) Pub. No.: US 2025/0299320 A1
(43) Pub. Date: Sep. 25, 2025

(54) APPEARANCE INSPECTION METHOD, INSPECTION AREA DESIGNATION METHOD AND PROGRAM

(71) Applicant: MITUTOYO CORPORATION, Kawasaki (JP)

(72) Inventor: Yoshitaka Izumi, Kanagawa (JP)

(21) Appl. No.: 19/083,095

(22) Filed: Mar. 18, 2025

(30) Foreign Application Priority Data
Mar. 25, 2024 (JP) 2024-048483

(51) Int. Cl. G06T 7/00

(52) U.S. Cl. CPC G06T 7/0008; G06T 2207/30148

(57) ABSTRACT

An appearance inspection method that can be used to inspect for solder defects using an image measuring apparatus is provided. An appearance inspection method inspects solder bumps formed on the pads of the inspection target based on an image of an inspection target. The appearance inspection method comprises: an inspection area designation step for designating the inspection area in the image of the inspection target; a pad area detection step for detecting a pad area included in the inspection area; a bump area detection step for detecting a bump area included in the inspection area; and a defect judgment step for judging the presence or absence of the defect based on the detected pad area and/or bump area.

### CROSS-REFERENCE TO RELATED APPLICATION

This non-provisional application claims priority under 35 U.S.C. § 119 (a) from Japanese Patent Application No. 2024-048483, filed on Mar. 25, 2024, the entire contents of which are incorporated herein by reference.

### BACKGROUND OF THE INVENTION

### Field of the Invention

The present invention relates to an appearance inspection method and program for inspecting the appearance of a measurement target based on an image obtained by capturing the measurement target.

### Description of the Related Art

An image measuring apparatus is an apparatus that captures an image of the measurement target (hereinafter referred to as “workpiece”), analyzes the image, extracts the point cloud of the edges contained in the image, and evaluates the distance, inclination, diameter, width or the like of geometric shapes such as lines, circles, and polygons or the like approximated from the extracted edge point cloud. In addition to evaluating geometric shapes, the recent image measuring apparatus is also implemented with algorithms that detect defects such as contamination on the workpiece, foreign objects inside hole shapes, minute chips, deformation, and burrs, and defect inspection based on the image is realized (see, for example, JP2020-071106).

### SUMMARY OF THE INVENTION

### Problems to be Solved by the Invention

In recent years, due to the rising demand for semiconductors, there has been a growing demand for inspection of solder defects in printed circuit boards, etc. However, no algorithm for inspecting solder defects using the image measuring apparatus has been realized.

Considering the above problems, the object of the present invention is to provide an appearance inspection method that can perform solder defect inspection using an image measuring apparatus, and a program that realizes such an appearance inspection method.

### Means for Solving the Problems

An appearance inspection method according to one aspect of the present invention inspects solder bumps formed on pads of the inspection target based on an image of the inspection target. The appearance inspection method includes: an inspection area designation step for designating the inspection area in the image of the inspection target; a pad area detection step for detecting a pad area included in the inspection area; a bump area detection step for detecting a bump area included in the inspection area; and a defect judgment step for judging the presence or absence of the defect based on the detected pad area and/or bump area.

### BRIEF DESCRIPTION OF THE DRAWINGS

FIG. 1 is a perspective view showing an example of the configuration of the image measuring apparatus 1.

FIG. 2 is a schematic diagram showing a configuration of the image capturing unit 120 along with the stage 100.

FIG. 3 is a block diagram showing a configuration of the position acquiring unit 110.

FIG. 4 is a block diagram showing a configuration of a computer main body 141.

FIG. 5 shows an example of a view of the screen display.

FIG. 6 shows an example of an appearance inspection view.

FIG. 7 is a flowchart showing the procedure of the appearance inspection.

FIG. 8 is a flowchart showing an example of a subroutine of the appearance inspection.

FIG. 9 is a flowchart showing an example of a subroutine of the appearance inspection.

FIG. 10 shows an image transition diagram in the process of the appearance inspection.

FIG. 11 is a flowchart showing an example of the procedure of the automatic designation of the inspection area.

FIG. 12 is a flowchart showing an example of the subroutine of the automatic designation of the inspection area.

FIG. 13 shows an image transition diagram in the process of the automatic designation of the inspection area.

### DETAILED DESCRIPTION OF THE EMBODIMENTS

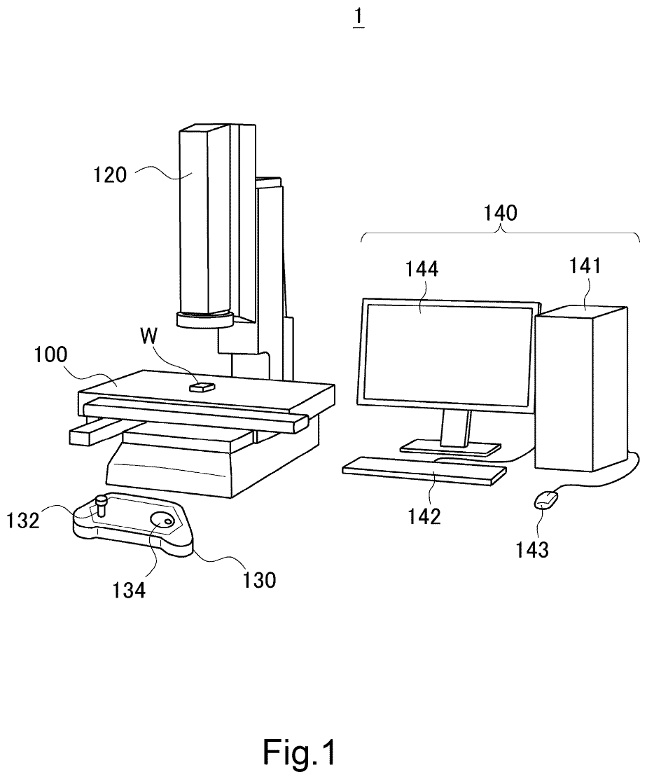

Hereinafter, embodiments of the present invention will be described with reference to the drawings. FIG. 1 is a perspective view showing the internal structure of an image measuring apparatus 1. The image measuring apparatus includes a stage 100, a position acquiring unit 110, an image capturing unit 120, a remote box 130, and a computer system 140.

The stage 100 is arranged so that its upper surface is horizontal, and a workpiece (target of the measurement or inspection) W is placed on the upper surface. At least the part of the top surface of the stage 100 where the workpiece W is placed is formed of a material that transmits light, such as glass. The stage 100 is driven by an X-axis drive motor and a Y-axis drive motor, which are not shown in the drawings, and can move in the X-axis direction and Y-axis direction parallel to the horizontal plane. The drive control signals for the drive motors of each axis are provided from the remote box 130 and computer system 140 described later to the drive motors of each axis.

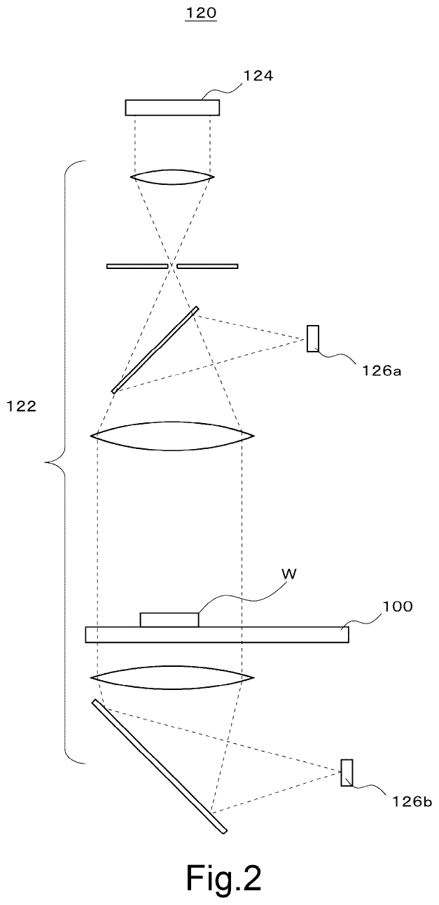

FIG. 2 is a schematic diagram showing a configuration of the image capturing unit 120 along with the stage 100. The image capturing unit 120 includes an optical system 122, an image sensor 124, and a light source 126. The optical system 122, for example, consists of a telecentric optical system that combines a plurality of lenses and an aperture. In a telecentric optical system, the main rays can be considered to be parallel light, so the dimensions in the captured image do not depend on the position in the Z-axis direction (height direction). For this reason, telecentric optical system is suitable for measuring the workpiece W with undulations (e.g., steps or holes). The light source 126 irradiates light on at least the part of the workpiece W to be imaged under the control of the computer system 140 when the image of the workpiece W is captured. In this embodiment, there is a light source 126a for epi-illumination that irradiates light from above (i.e., towards the image sensor 124) towards the workpiece W via the optical system 122, and a light source 126b for transillumination that irradiates light from below (i.e., towards the back of the stage 100) towards the workpiece W. The image sensor 124 is a two-dimensional image sensor such as a CCD or CMOS. The image of the workpiece W is formed on the light-receiving surface of the image sensor 124 by the optical system 122. The image sensor 124 captures the formed image and outputs image data in a predetermined format. This image data contains information on the pixels that constitute the image, as well as an index that indicates the order of image capture. The image capturing unit 120 transmits the image signals output by the image sensor 124 to the computer system 140. The computer system 140 and the image capturing unit 120 are connected using a general-purpose communication standard such as USB (Universal Serial Bus). In addition, the image capturing unit 120 outputs a trigger signal to the latch unit 118 at the timing of completing the capturing of one image (one frame).

The image capturing unit 120 is driven by a Z-axis drive motor that is not shown in the drawings, and is capable of moving in the Z-axis direction (i.e., a direction perpendicular to the top surface of the stage 100). Focus adjustment is performed by adjusting the Z-axis position of the image capturing unit 120. The drive control signal for the Z-axis drive motor is provided from the remote box 130 and computer system 140 described later.

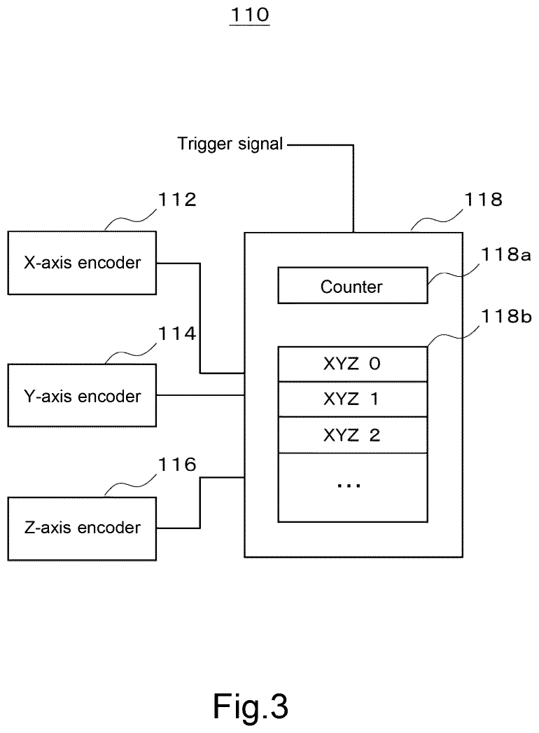

FIG. 3 is a block diagram showing configuration of position acquiring unit 110. The position acquiring unit 110 has an X-axis encoder 112, a Y-axis encoder 114, a Z-axis encoder 116, and the latch unit 118.

The X-axis encoder 112 measures and outputs the position coordinate in the X-axis direction of the stage 100. The Y-axis encoder 114 measures and outputs the position coordinate in the Y-axis direction of the stage 100. The Z-axis encoder 116 measures and outputs the position coordinate in the Z-axis direction of the image capturing unit 120. Each encoder is equipped with a graduated scale and a scale reader that reads the scale. The scale can be attached to the movable parts of the stage 100 and image capturing unit 120 along each axis. On the other hand, the scale readers are placed on the non-movable parts.

The latch unit 118 includes a counter 118a and a buffer 118b. The counter 118a increases the count value by 1 when an external trigger signal (e.g., pulse signal) is supplied. The value of counter 118a is reset as appropriate based on the instructions of computer system 140. The buffer 118b has a storage area for a plurality of addresses, and at the timing when the trigger signal is supplied, the output value of the encoder of each axis is latched and stored in the storage area of the address corresponding to the count value of the counter 118a. The trigger signal may be supplied, for example, from the image sensor 124 at the timing when the capture of one image is completed. The position coordinates of each axis held by the latch unit 118 are associated with address values (i.e., count values) and are taken into the computer system 140 as appropriate. The computer system 140 and the latch unit 118 are connected using a general-purpose communication standard such as USB (Universal Serial Bus). The image data and position coordinates are imported into the computer system 140 separately, but the image data is indexed to indicate the order in which they were captured, and the position coordinates are associated with a count value to indicate the order in which they were captured, so that even if they were imported into the computer system 140 asynchronously, they can be associated after being imported.

Returning to FIG. 1, the remote box 130 is an operating means for setting the position of the stage 100 and the image capturing unit 120, and transmits drive control signals to the X-axis drive motor, Y-axis drive motor, and Z-axis drive motor via wired or wireless communication in response to operation by the operator. The remote box 130 includes a joystick 132 and a jog shuttle 134. The joystick 132 is an input device for setting the position of the stage 100, and the remote box 130 sends drive control signals to move the stage 100 in the X-axis and Y-axis directions according to the tilt direction of the joystick 132. The jog shuttle 134 is an input device for setting the Z-axis direction position of the image capturing unit 120, and the remote box 130 transmits drive control signals to move the image capturing unit 120 in the Z-axis direction according to the rotation direction, rotation amount, and rotation speed of the jog shuttle 134.

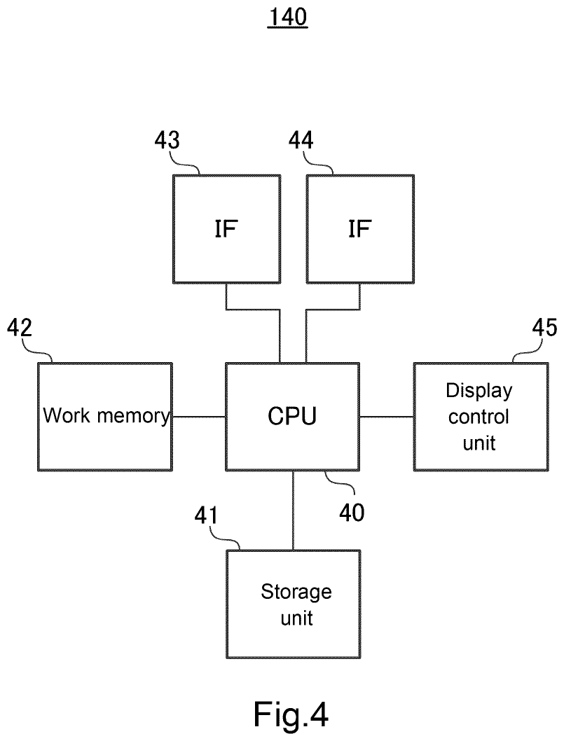

The computer system 140 includes a computer body 141, a keyboard 142, a mouse 143, and a display 144. FIG. 4 is a block diagram showing a configuration of a computer main body 141. The computer body 141 includes a CPU 40 that serves as the center of control, a storage unit 41, a work memory 42, interfaces 43 and 44 (shown as “IF” in FIG. 4), and a display control unit 45 that controls the view on the display 144.

Operator instruction information input from the keyboard 142 or the mouse 143 is input to the CPU 40 via the interface 43. The interface 44 is connected to the image capturing unit 120 and the stage 100, supplies various control signals from the CPU 40 to the image capturing unit 120 and the stage 100, receives various status information and measurement results from the image capturing unit 120 and the stage 100, and inputs them to the CPU 40.

The display control unit 45 causes the image captured by the image capturing unit 120 to be displayed on the display 144. In addition, the display control unit 45 causes the display 144 to show the images captured by the image capturing unit 120, as well as the interface for inputting control instructions to the image measuring apparatus 1 and the interface for the tool for analyzing the captured images.

The work memory 42 provides a work area for various types of processing of the CPU 40. The storage unit 41 is configured by, for example, a hard disk drive, a RAM, and the like, and stores programs to be executed by the CPU 40, the image data captured by the image capturing unit 120, and other data.

Based on various types of information input via the respective interfaces, the operator instructions, the measurement definition program (part program) stored in the storage unit 41, and the like, the CPU 40 performs various types of processing including: control of the image capturing unit 120, X-axis drive motor, Y-axis drive motor, and Z-axis drive motor, etc., setting of the moving path of the image capturing unit 120 and adjustment of the moving speed and exposure time, adjustment of the light intensity of the light source 126, image capturing of two-dimensional images by the image capturing unit 120, image stitching processing that pastes together a plurality of partial images, and analysis of the overall image obtained by image capturing, etc.

Hereafter, the measurement performed by using the image measuring apparatus 1 is explained.

### Basic Image Measurement

First, the operator moves the stage 100 so that the workpiece W enters the imaging field of view by operation of the joystick 132 or by control of the computer system 140. Then, the Z-axis position of the image capturing unit 120 is adjusted so that the workpiece W is in focus. After the workpiece W is in focus, an image for measurement is captured using the image sensor 124. At this time, the coordinates of stage 100 output by the X-axis encoder 112 and Y-axis encoder 114 are captured by the computer system 140 along with the captured image, and stored in the storage unit 41. Specifically, a pulse is output as a trigger signal to the latch unit 118 at the timing when the image capturing unit 124 completes capturing one image. The latch unit 118 latches and holds the position coordinates of each axis at the timing of the rising transition of the pulse (i.e., almost simultaneously with the completion of image capturing). The computer system 140 acquires image signals from the image capturing unit 124 and acquires the position coordinates when the image was captured from the latch unit 118, and stores them in association with each other.

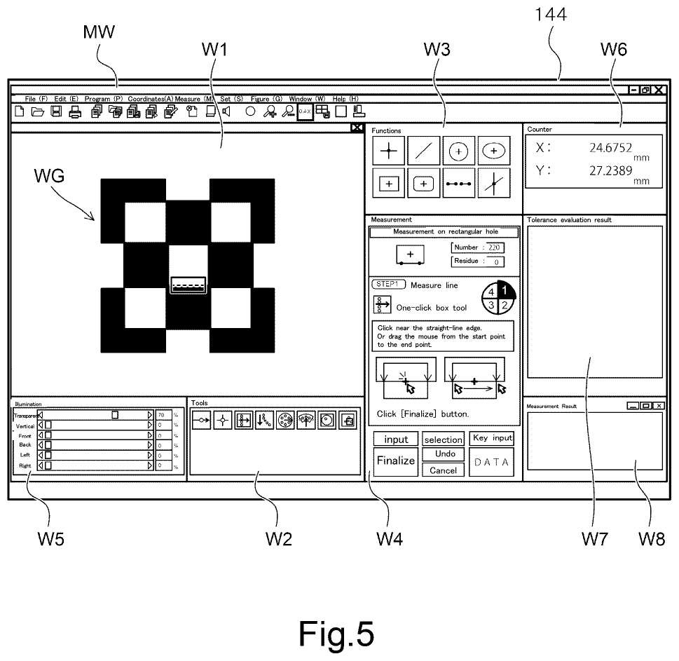

The computer system 140 displays the obtained images for measurement on the display 144, together with the interface of the measurement tool for analyzing the image. FIG. 5 shows an example of a view of the screen display. This screen display is shown on the display 144 by a program (measurement application software) executed on the CPU 40 of the computer system 140.

As shown in FIG. 5, when the program is executed, the main window MW is displayed on the display 144. In addition, a plurality of windows (Windows W1 to W8) is displayed within the main window MW. On the top of the main window MW, icons for menus, various operations and settings are also displayed. In this embodiment, an example is shown where eight windows are displayed, but it is also possible to display more than eight windows as necessary, or to divide, integrate or omit windows according to their purpose. The layout of each window can also be freely changed by operation of the operator.

In the first window W1, the image WG of the workpiece W captured by the image capturing unit 120 is displayed. The operator can adjust the position of the image WG of the workpiece W displayed in the first window W1 by operating the mouse 143 or the joystick 132 of the remote box 130, for example. In addition, the operator can also expand or shrink the image WG of the workpiece W by selecting an icon with the mouse 143, for example.

In the second window W2, icons of the measurement tools that can be selected by the operator are displayed. The icons for the measurement tools are provided to correspond to the method of designating the measurement points from the image WG of the workpiece W. As specific examples of measurement tools, there are straight edge detection tools, circular edge detection tools, etc.

In the third window W3, icons of functions that can be selected by the operator are displayed. The icons of functions are provided for each measurement method. For example, there are methods for measuring the coordinates of a single point, measuring the length of a straight line, measuring a circle, measuring an ellipse, measuring a square hole, measuring a long hole, measuring the pitch, and measuring the tolerance between two lines. The computer system 140 performs measurements of dimensions such as the length of a straight line, the distance between straight lines, and the diameter of a circle, and evaluations of deviations (errors) from ideal geometric shapes such as straightness, roundness, and parallelism, according to the operator's selection.

In the fourth window W4, the guidance that shows the operating procedure for measurement is displayed.

In the fifth window W5, various sliders for controlling the illumination from the image capturing unit 120 to the workpiece W are displayed. The operator can operate this slider to irradiate the desired illumination onto the workpiece W.

In the sixth window W6, the XY coordinate values of the stage 100 are displayed. The XY coordinate values displayed in the sixth window W6 are the X-axis coordinate and Y-axis coordinate of the stage 100 relative to a predetermined coordinate origin.

In the seventh window W7, a tolerance judgment result is displayed. Namely, when a measurement method that can perform tolerance judgment is selected, the result of the judgment is displayed in the seventh window W7.

In the eighth window W8, a measurement result is displayed. Namely, when a measurement method that obtains a measurement result by a predetermined calculation is selected, the measurement result is displayed in the eighth window W8. The details of the tolerance judgment results for the seventh window W7 and the measurement results for the eighth window W8 are omitted from the drawing.

### Appearance Inspection for Solder Defects

In the image measuring apparatus 1 of the present embodiment, the program (measurement application software) executed by the CPU 40 of the computer system 140 provides a function to perform an appearance inspection focusing on solder defects (hereinafter simply referred to as an appearance inspection) in addition to the basic image measurement described above. In the following description, when there is no particular reference to the subject of the processing, it should be understood that the subject is the program executed by the CPU 40 of the computer system 140.

In this system, the solder defects include the following three types of defects.
(1) Missing bump: This is a defect where no bump candidates exist within the inspection area.
(2) Out of the designed range: This is a defect in which the candidate bump within the inspection area is outside the specified designed value range.
(3) Misalignment: This is a defect in which the distance from the bump candidate to the pad (the shortest distance between the outer edges) is less than the threshold value.

The range of design values used to judge whether or not a value is out of range and the threshold values used to judge whether or not there is a misalignment can be changed by the user on the screen of the measurement application software.

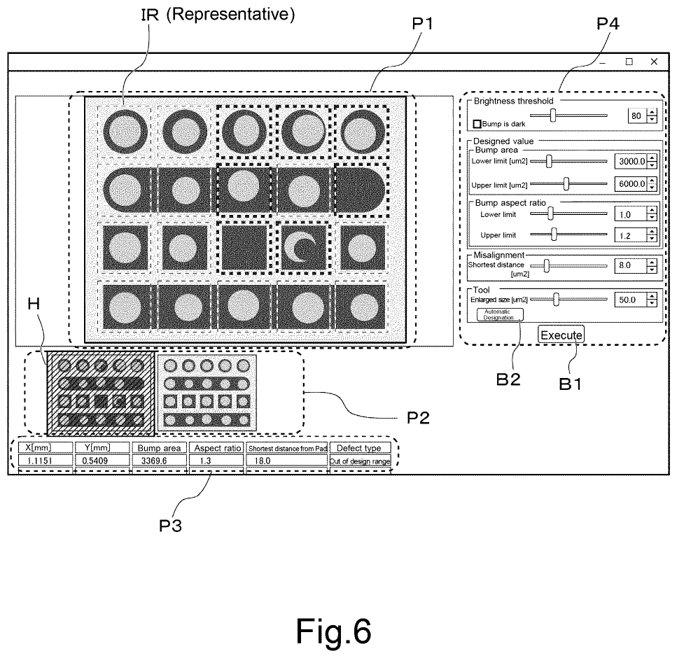

FIG. 6 shows an example of a screen for the appearance inspection (hereinafter referred to as an appearance inspection view). The appearance inspection view consists of an image pane P1, a filmstrip pane P2, a measurement result display pane P3, and a control pane P4.

The image pane P1 is the area that displays the image for the appearance inspection. Image processing and defect judgment are performed on the image displayed in this image pane P1 under the conditions set in the control pane P4.

When a drag operation is performed using the mouse on the image pane P1, a rectangular area with a line connecting the starting point and end point of the drag as its diagonal line can be designated as the inspection area IR for the defect judgment on the displayed image. When this drag operation is performed, an inspection area tool, which shows the contour of the designated rectangular area, is displayed overlaid on the image in the image pane P1. The inspection area tool can be selected by clicking, and the size can be changed by dragging the handle that appears upon selection. The area tool can also be deleted by pressing the DEL key on the keyboard while the tool is in a selected state.

The filmstrip pane P2 is an area that displays images loaded for appearance inspection in thumbnail style. When one of the images displayed in the filmstrip pane P2 is double-clicked, the image is displayed in the image pane P1 and becomes the subject of the image processing and defect judgment. In the initial state immediately after loading images, a predetermined image (for example, the image that comes first when sorted by name or by date and time of saving) becomes the selected state in the filmstrip pane P2 and displayed in the image pane P1.

If the image processed and judged in the image pane P1 has a defect, a hatching H is added to the image in filmstrip pane P2 in which the defect is found, so that it can be easily distinguished from images in which the defect is not found.

The measurement result display pane P3 is an area that displays a list of defect information when a defect is found in the image displayed in the image pane P1. If there is a plurality of defects, information on all defects is displayed in a list format.

The control pane P4 is the area where the user interface for setting the conditions for image processing and defect judgment performed on the image displayed in the image pane P1 is displayed. Using the user interface provided in the control pane P4, it is made possible to set parameters for image processing (e.g., threshold values for binary conversion, whether or not to invert brightness values, etc.) and parameters for defect judgment (e.g., design values for bumps, minimum allowable distance to pads, size of inspection area tool, etc.). The user interface may be provided as a graphical user interface (GUI) control, such as a slider bar or switch, in addition to a way allowing direct input of numerical values. In addition, a button B1 for entering a command to perform an appearance inspection, a button B2 for entering a command to perform automatic designation of the inspection area, etc., are also provided in the control pane P4.

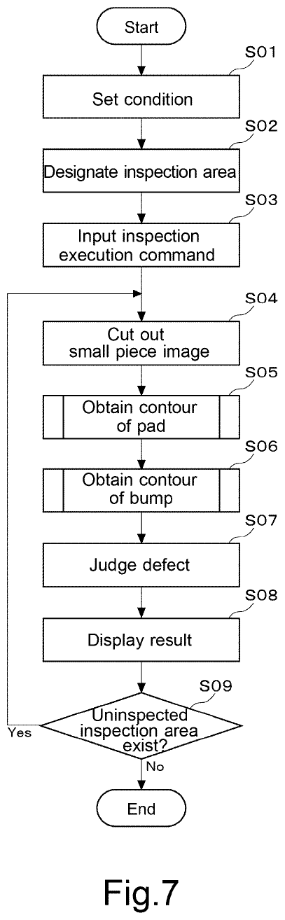

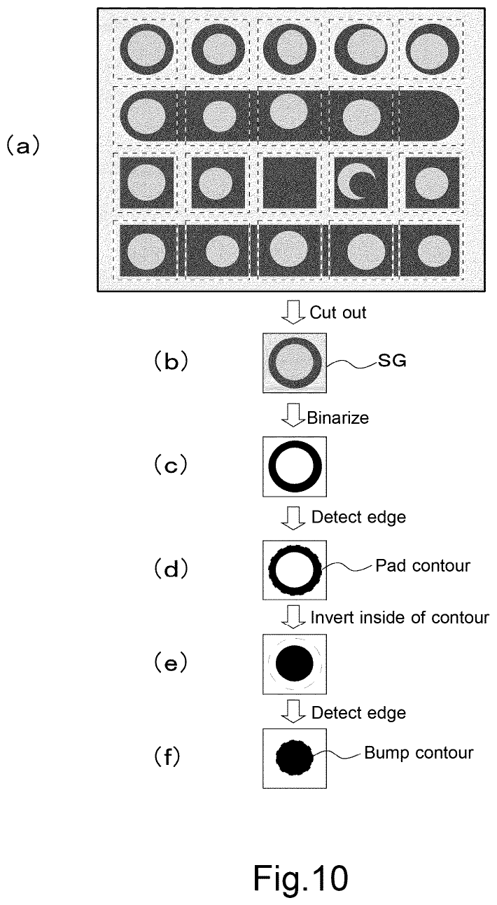

Next, the procedure for performing an appearance inspection is explained, using the example of designating the inspection area IR by user operation on the screen of the measurement application software, referring to the flowcharts shown in FIGS. 7 to 9 and the image transition diagram shown in FIG. 10.

Before starting the appearance inspection, the user selects the menu for performing the appearance inspection in the program (measurement application software). In response, the display 144 shows the appearance inspection view. Then the program prompts the user to designate one or more images to be inspected. When the user specifies image files in response, the image files are loaded and all the loaded images are displayed in the film strip pane P2, while the first image ((a) in FIG. 10) is displayed in the image pane P1.

The image displayed in the image pane P1 is subject to appearance inspection. If the user wishes to perform the appearance inspection on another image than the first one, the user can double-click on the desired image in the filmstrip pane P2 to display the desired image in the image pane P1. In this way, the image to be inspected is displayed in the image pane P1, and the appearance inspection is started.

When the appearance inspection is started, the program first accepts various condition settings by the user (step S01). Specifically, the program accepts the setting of image processing parameters (binarization threshold, etc.), defect judgment parameters (allowable defect width, height, area, etc.), allowable number of defects, etc. These settings may be changed at any given time.

Then, the inspection area IR is designated on the image WG of the workpiece W displayed in the image pane P1 by operating the mouse 143 or the joystick 132 of the remote box 130 (step S02). The method for specifying the target area is arbitrary, but for example, by dragging the mouse 143 on the image pane P1, and a rectangular area with a line connecting the starting point and end point of the drag as its diagonal line may be specified as the inspection area IR. For the designated inspection area IR, the inspection area tool is displayed as a rectangular frame overlaid on the image of the workpiece WG in the image pane P1.

When the user designates the inspection area IR, the inspection area IR may be designated to surround the pad PD where the bump BP is to be formed. For example, if the pad PD does not lie entirely within the image WG, such as a pad PD that crosses the image WG horizontally, an inspection area IR may be designated around the position in the pad PD where the bump BP is to be formed. Since the outer edge of the pad PD is necessary for judging misalignment, the inspection area IR should be specified so that at least part of the outer edge of the pad PD is included in the inspection area IR.

The number of inspection areas IR designated for a single image WG is arbitrary. The user may designate inspection areas IR for the number of bumps BP that need to be inspected. The computer system 140 may store the information (position and range) of the inspection areas IR designated as described above in the storage unit 41. The method of using the information on the inspection area IR stored in storage unit 41 in subsequent inspection is described later.

Then, when the command to execute the appearance inspection is input via the user interface (step S03), the judgment of solder defects is made for each inspection area IR designated as described above, according to the procedure explained below.

First, the inspection area IR to be judged is cut out from the image WG to make a rectangular small piece image SG (step S04; (b) in FIG. 10). Then, the contour of the pad PD is obtained in the small piece image SG (step S05).

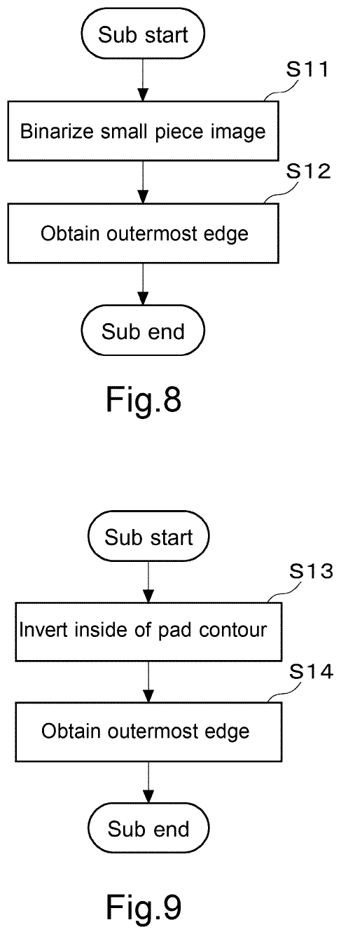

The contour of the pad PD in step S05 can be obtained, for example, by the subroutine (steps S11-S12) shown in FIG. 8. That is, the cut out small piece image SG is binarized (step S11; (c) in FIG. 10). The threshold for this binarization is set so that the pad PD is black (value 0), and the bump BP and the area where neither the bump BP nor the pad PD is provided are white (value 1). When performing binarization, noise elimination and other processing may be performed as necessary. Next, for the binarized small piece image SG in step S11, the edges (the borders between the black and white regions) are detected, and the outermost edge is obtained as the contour (outer edge) of the pad PD (step S12; (d) in FIG. 10).

Returning to FIG. 7, following Step S05, the contour of the bump BP is obtained in the small piece image SG (Step S06).

The contour of the bump BP in step S06 can be obtained, for example, by the subroutine (steps S13-S14) shown in FIG. 9. That is, the binarized values (i.e., black and white) only within the contour of the pad PD obtained in step S12 are inverted (step S13). Thereby, as shown in (e) in FIG. 10, the edges that form the boundary between the inside and outside of the pad PD disappear from the small piece image SG. Next, the edges of the small image SG, which has undergone the processing in Step S13, are detected again, and the outermost contour is obtained among them, and this is used as the contour (outer edge) of the bump BP (Step S14; (f) in FIG. 10).

Returning to FIG. 7, based on the contour of the pad PD and the contour of the bump BP obtained in steps S05 to S06, the feature values (e.g., the area and aspect ratio of the bump BP, the distance between the pad PD and the bump BP, etc.) are calculated for the pad PD and the bump BP and the solder defect is judged (step S07). Specifically, if the contour of bump BP is not obtained in step S05, it is judged to be a “missing bump”. If the area surrounded by the contour of the bump BP obtained in step S06 is outside the set design value range, it is judged to be “out of the designed range”. If the distance (shortest distance) between the contour of pad PD obtained in step S04 and the contour of bump BP obtained in step S06 is less than the set threshold value, it is judged to be “misalignment”. If none of the above criteria are met, it is assumed that there is no solder defect.

Then, the result of the judgment is displayed on the display 144 (step S08). Those judged as defects by the judgment may be displayed in the measurement result display pane P3 and overlaid on the workpiece image WG in the image pane P1. The way of displaying the defect in the image pane P1 is arbitrary. For example, for the inspection area IR that has been judged to have a defect, the outline color can be changed, or the bump that has been judged to be defective is displayed by filling the inside of the outline with a conspicuous color (e.g., red), so that the user can easily recognize the defect that has been found. FIG. 6 shows an example of displaying the contour of the inspection area IR, which has been judged to have a defect, in a bold line.

If there are any inspection areas IR that have not been inspected (step S09; Yes), the process is returned to step S04, and steps S04 to S08 are performed for all the inspection areas IR designated in step S02. If there is no uninspected inspection area IR (step S09; No), the appearance inspection is ended.

In this way, it is possible to use an image measuring apparatus to inspect solder defects, and it is possible to perform measurement and inspection of soldered parts using a single system.

### Storage and Reuse of Inspection Area Information

In the above example, the inspection area IR was designated by a user operation on the measurement application software screen, but the inspection area IR may be designated based on pre-stored inspection area information. The inspection area information includes, at least for the desired number of inspection areas IR, the location of the individual inspection areas IR (e.g., the location coordinates of the center) and is stored in the storage unit 41. The position of each inspection area IR included in the inspection area information may be absolute coordinates in the coordinate system of the image measuring apparatus 1, but it is preferable to use relative coordinates based on the reference position within the workpiece W. The inspection area information may also include the size of each inspection area IR (e.g., the height and width of a rectangle). The inspection area information may be stored as the information for the inspection area IR designated by the user on the screen of the measurement application software, or it may be stored as the information for the inspection area IR designated by the automatic designation described below. Alternatively, these can be stored after being edited by the user.

To apply the inspection area information to the appearance inspection, instead of designating each inspection area IR by user operation on the screen of the measurement application software, as in step S02 of the appearance inspection procedure described above, the inspection area information stored in the storage unit 41 is read out and applied to the image to be inspected. If the inspection area information only includes the position information for each inspection area IR and does not include size information, the inspection area IR of a predetermined size (for example, the size set by the user in the measurement application software) may be designated. This allows the user to designate a plurality of inspection areas IR at once without having to designate each inspection area IR manually. It is effective when performing repeated appearance inspections of workpieces W with the same specification. Once the inspection areas IR have been designated, it is possible to judge whether or not there are any defects in each of the designated inspection areas IR in the same way as the appearance inspection procedure described above.

In the inspection area information, the conditions for appearance inspection may be further associated with each inspection area IR. For example, for each inspection area IR, the range of design values or threshold values used for judgment may be defined, and during an appearance inspection, the presence or absence of defects may be judged using the range of design values or threshold values defined in the inspection area information. It is also possible to define the type of judgment to be applied to each individual inspection area IR (for example, only “missing bump” should be judged). In this way, it is possible to judge whether or not there are defects in a plurality of inspection areas IR under different conditions.

### Automatic Designation of Inspection Area

In the example above, the inspection area IR was specified by the user on the screen of the measurement application software, but it is also possible to automatically generate the inspection area IR for the image WG of the workpiece W using image processing (automatic designation of the inspection area). The automatic designation of the inspection area may be performed on a workpiece for which it has been confirmed that all bumps have been correctly formed (reference workpiece), prior to the judgment of whether or not there are defects in the appearance inspection (and the judgment of the acceptability of the workpiece W). The inspection area IR automatically designated for the reference workpiece may be stored in the storage unit 41 as inspection area information, and when judging whether or not each workpiece W has a defect (and judging the acceptability of the workpiece W), the inspection area information may be read out and used to designate the inspection area IR.

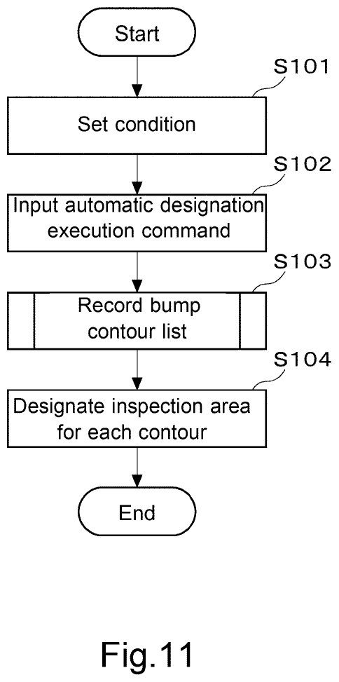

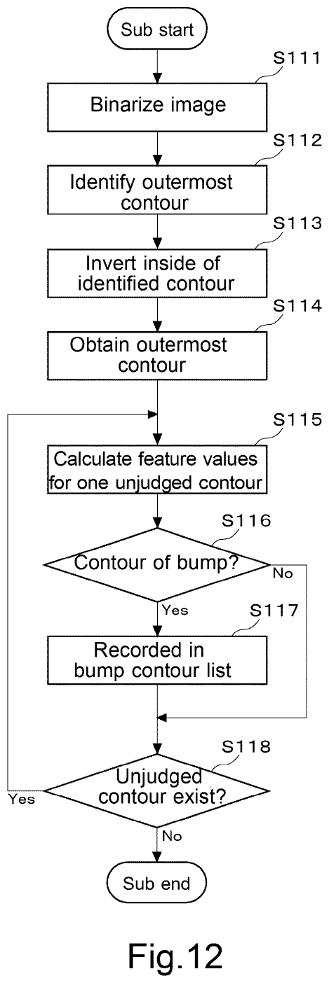

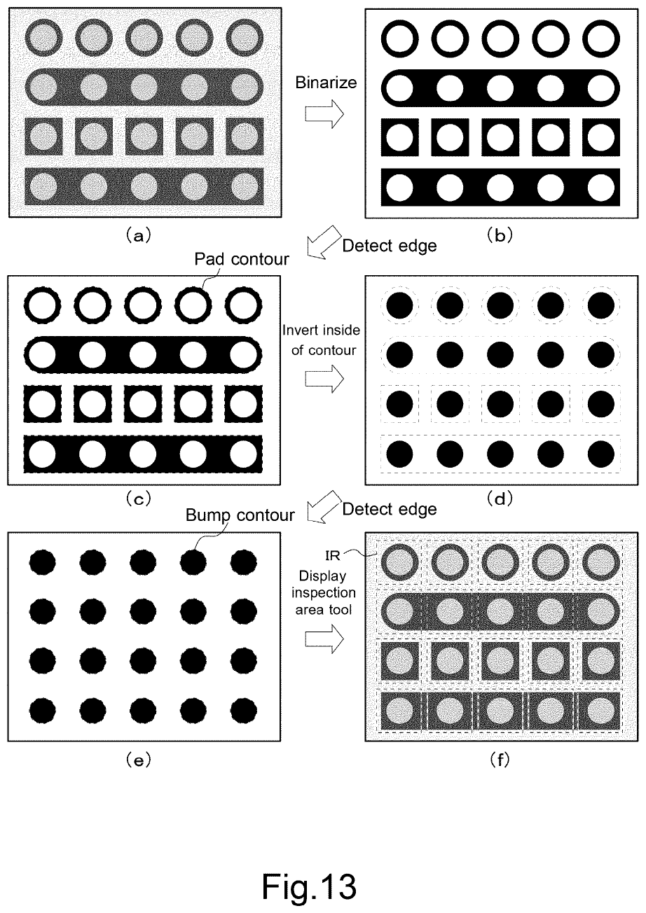

In the following, a procedure for automatic designation of the inspection area using the reference workpiece is explained, referring to the flowchart shown in FIGS. 11 and 12 and the image transition diagram shown in FIG. 13.

The automatic designation of the inspection area is started with the image of the reference workpiece (shown in (a) in FIG. 13) displayed in the image pane P1 on the appearance inspection view shown in FIG. 6. Once the processing starts, the program first accepts the user's settings for various conditions (step S101). Specifically, the program accepts the setting of image processing parameters (binarization threshold, etc.), defect judgment parameters (allowable defect width, height, area, etc.), allowable number of defects, etc.

When a command to execute the automatic designation is entered (step S102), the contours of all the bumps BP appearing in the image of the reference workpiece are obtained and recorded in the bump contour list (step S103). The contours of the bumps BP in the image of the reference workpiece can be obtained, for example, by the subroutine shown in FIG. 12 (steps S111 to S118). Namely, the image of the reference workpiece is binarized (step S111; (b) in FIG. 13), the edges of the image binarized in step S111 are detected, and the outermost contour is identified (step S112; (c) in FIG. 13). The contour (outer edge) of the pad PD is identified at this time. Then, the binary value (i.e., black and white) inside the outermost contour identified in step S112 is inverted (step S113). Thereby, the edge that forms the boundary between the inside and outside of the pad PD disappears, as shown in (d) in FIG. 13. Next, the image of the reference workpiece that is subjected to the processing in step S113 is re-processed to detect edges, and the outermost contour is obtained (step S114; (e) in FIG. 13).

Then, for one of the obtained contours that have not yet been judged, the feature values (e.g., the dimensions of the contour, the size of the smallest bounding rectangle, etc.) are calculated (step S115). Furthermore, based on the calculated feature values, it is judged whether or not the acquired contour is the contour of a bump BP, and if it is judged to be the contour of a bump BP (step S116; Yes), the contour is recorded in the bump contour list (step S117). On the other hand, if it is judged that it is not the contour of the bump BP (step S116; No), the contour is not recorded in the bump contour list, and processing is advanced to step S118. If there are still contours that have not been judged as being bump BP contours (step S118; Yes), the process is returned to step S115, and the judgment of whether or not they are bump BP contours is performed for all the contours obtained in step S114. When there are no more contours to be judged (step S118; No), the bump contour list will contain the contours of all the bumps BP that appear in the image of the reference workpiece.

Returning to FIG. 11, the inspection area IR is designated for all the contours recorded in the bump contour list (step S104), and the automatic designation process ends. At this time, in the image pane P1, the inspection area tool is displayed for each of the automatically specified inspection areas IR, overlaid on the image of the workpiece WG ((f) in FIG. 13). The method for designating the inspection area IR for each contour is arbitrary. For example, a rectangle of a predetermined size centered on the reference position (e.g., the center or the center of gravity) of each contour may be used as the inspection area IR. Alternatively, the inspection area IR may be a rectangle that surrounds each contour at a predetermined distance.

In this way, it is possible to automatically designate the inspection area IR for the many bumps BP contained in the image of the reference workpiece. If the inspection area information for the automatically designated inspection area is stored, the same inspection area information can be repeatedly applied to the designation of the inspection area for the images of individual workpieces W to be inspected. In the example above, the automatic designation of the inspection area was applied to the image of the reference workpiece, but it is also possible to apply the automatic designation of the inspection area to the image of each individual workpiece to be inspected.

According to the appearance inspection described above, the image measuring apparatus 1 can be used to inspect solder defects, and measurement and inspection of solder portions can be performed in a single system. In addition, workpieces with a large number of solder portions to be inspected can be efficiently inspected.

### Modification of Embodiment

The present invention is not limited to the examples of the above embodiments, and any variation, improvement, and the like are included in the present invention to the extent that the object of the present invention can be achieved. For example, the method of obtaining the contours of pad PD and bump BP is not limited to the method disclosed in the above embodiments (i.e., the subroutine shown in FIGS. 8 and 9), and any method may be employed.

Further, an invention in which a person skilled in the art appropriately adds, deletes, or changes the design of the above-described embodiment or concrete example thereof as appropriate is also included in the scope of the present invention as long as it has the gist of the present invention.

With respect to the embodiments including the above examples, the following appendixes are further disclosed.
(Appendix 1) An appearance inspection method that inspects solder bumps formed on pads of the inspection target based on an image of an inspection target comprising:
   an inspection area designation step for designating the inspection area in the image of the inspection target;
   a pad area detection step for detecting a pad area included in the inspection area;
   a bump area detection step for detecting a bump area included in the inspection area;
   a defect judgment step for judging the presence or absence of the defect based on the detected pad area and/or bump area.
(Appendix 2) The appearance inspection method according to appendix 1, wherein in the inspection area designation step, a plurality of inspection areas is designated in the image of the inspection target, and
   wherein the pad area detection step, the bump area detection step, and the defect judgment step are performed for each of a plurality of designated inspection areas.
(Appendix 3) The appearance inspection method according to appendix 1 or 2, wherein in the inspection area designation step, the inspection area is designated based on predetermined inspection area information, and
   the inspection area information includes at least information indicating the location of the inspection area.
(Appendix 4) The appearance inspection method according to appendix 3, wherein the inspection area information further includes information indicating the size of the inspection area.
(Appendix 5) The appearance inspection method according to appendix 3, wherein the inspection area information further includes information related to the judgment criteria used in the defect judgment step.
(Appendix 6) The appearance inspection method according to appendix 1, further including a step of cutting out a small piece image of the inspection area from the image of the inspection target, and
   wherein the pad area detection step includes:
      a step of binarizing the small piece image;
      a step of detecting edges in the binarized small piece image; and
      a step of obtaining the outermost edge of the detected edges as the contour of the pad area, and
   wherein the bump area detection step includes:
      a step of inverting the binarized brightness values within the contour of the pad area for the binarized small piece image;
      a step of detecting edges in the small piece image in which the brightness values within the contour of the pad area have been inverted; and
      a step of obtaining the outermost edge of the detected edges as the contour of the bump area.
(Appendix 7) The appearance inspection method according to appendix 1 or 2, wherein the defect to be judged in the defect judgment step includes one or more of missing bump, out of designed range, and misalignment.
(Appendix 8) A program for causing a computer to perform the appearance inspection method according to appendix 1 or 2 and a non-transitory recording medium on which said program is recorded.
(Appendix 9) An inspection area designation method used in an appearance inspection method that inspects solder bumps formed on pads of an inspection target based on an image of the inspection target comprising:
   a bump area detection step for detecting one or more bump areas included in the image; and
   an inspection area designation step for designating an inspection area for each of the one or more detected bump areas.
(Appendix 10) The inspection area designation method according to appendix 9, further including an inspection area information storage step that stores inspection area information that includes at least information indicating the location of the inspection area designated in the inspection area designation step.
(Appendix 11) A program for causing a computer to perform the inspection area designation method according to appendix 9 or 10 and a non-transitory recording medium on which said program is recorded.

What is claimed is:

1. An appearance inspection method that inspects solder bumps formed on pads of the inspection target based on an image of an inspection target comprising:
an inspection area designation step for designating the inspection area in the image of the inspection target;
a pad area detection step for detecting a pad area included in the inspection area;
a bump area detection step for detecting a bump area included in the inspection area;
a defect judgment step for judging the presence or absence of the defect based on the detected pad area and/or bump area.

2. The appearance inspection method according to claim 1, wherein in the inspection area designation step, a plurality of inspection areas is designated in the image of the inspection target, and
wherein the pad area detection step, the bump area detection step, and the defect judgment step are performed for each of a plurality of designated inspection areas.

3. The appearance inspection method according to claim 1, wherein in the inspection area designation step, the inspection area is designated based on predetermined inspection area information, and
the inspection area information includes at least information indicating the location of the inspection area.

4. The appearance inspection method according to claim 3, wherein the inspection area information further includes information indicating the size of the inspection area.

5. The appearance inspection method according to claim 3, wherein the inspection area information further includes information related to the judgment criteria used in the defect judgment step.

6. The appearance inspection method according to claim 1, further including a step of cutting out a small piece image of the inspection area from the image of the inspection target, and
wherein the pad area detection step includes:
a step of binarizing the small piece image;
a step of detecting edges in the binarized small piece image; and
a step of obtaining the outermost edge of the detected edges as the contour of the pad area, and
wherein the bump area detection step includes:
a step of inverting the binarized brightness values within the contour of the pad area for the binarized small piece image;
a step of detecting edges in the small piece image in which the brightness values within the contour of the pad area have been inverted; and
a step of obtaining the outermost edge of the detected edges as the contour of the bump area.

7. The appearance inspection method according to claim 1, wherein the defect to be judged in the defect judgment step includes one or more of missing bump, out of designed range, and misalignment.

8. A non-transitory recording medium recording a program for causing a computer to perform the appearance inspection method according to claim 1.

9. An inspection area designation method used in an appearance inspection method that inspects solder bumps formed on pads of an inspection target based on an image of an inspection target comprising:
a bump area detection step for detecting one or more bump areas included in the image; and
an inspection area designation step for designating an inspection area for each of the one or more detected bump areas.

10. The inspection area designation method according to claim 9, further including an inspection area information storage step that stores inspection area information that includes at least information indicating the location of the inspection area designated in the inspection area designation step.

11. A non-transitory recording medium recording a program for causing a computer to perform the inspection area designation method according to claim 9.
